(19) United States
(12) Patent Application Publication
(10) Pub. No.: US 2019/0014158 A1
(43) Pub. Date: Jan. 10, 2019

(54) DEVICES AND METHODS PROVIDING A CENTRALLY MANAGED WEB COMMUNICATION FEATURE

(71) Applicant: Genband US LLC, Plano, TX (US)

(72) Inventors: Dany Sylvain, Qatineau, CA (US); Jeffrey Singman, Manalapan, NJ (US)

(21) Appl. No.: 15/645,653

(22) Filed: Jul. 10, 2017

(51) Int. Cl. H04L 29/06

(52) U.S. Cl. CPC H04L 65/1069; H04L 67/02

(57) ABSTRACT

According to one example, a method includes, with a service portal of a web communication service, receiving a first dataset from a computing device of a second entity, the first dataset including information to enable communication between a user device accessing a website of a first entity and an agent device of the second entity. The method further includes, with the service portal, creating a piece of code for insertion into content from the second entity that is configured for insertion into the website of the first entity, the piece of code to establish a communication session through the web communication service between the user device and the agent device. The method further includes transmitting the piece of code to the computing device of the second entity.

### BACKGROUND

Various organizations such as commercial businesses or government agencies often have multiple divisions or departments that are separately contactable. For example, a business may have a sales department, a service department, and a scheduling department. When a user calls the organization, he or she may be presented with a call tree that allows the user to select the department that he or she wishes to contact. In some cases, there are additional options after selecting the first option to help the user get in contact with the person or department he or she intends to contact.

As communication technology evolves, users may use other methods for voice communication than traditional phone technology. One such method includes WebRTC (Web Real Time Communication). WebRTC is a project by the World Wide Web Consortium (3C) to define a set of Application Programming Interfaces (APIs) and media handling mechanisms to enable browser-to-browser and browser-to-device applications for voice, video, and text. The introduction of WebRTC as a solution allows for the creation of new usage models for communication services. One new usage model includes the ability of a web user to simply initiate a real-time communication via a web application on the user's device (e.g., a personal computer, mobile device, etc.). In this model, the user can access an identifier (e.g., uniform resource identifier (URI)) pointing to a specific carrier communication ID (e.g., phone number, SIP user ID) through the web application to initiate the WebRTC communication session.

### BRIEF DESCRIPTION OF THE DRAWINGS

The present disclosure is best understood from the following detailed description when read with the accompanying figures.

FIG. 1 illustrates an example of the environment in which a user may contact a second entity through secondary content on a first entity's website, according to one example of principles described herein.

FIG. 2 is a diagram showing the environment in which various pieces of secondary content are provided on multiple websites, according to one example of principles described herein.

FIG. 3 is a flow diagram showing use of a centrally provided web communication feature, according to one example of principles described herein.

FIG. 4 is a diagram showing communication between a communication service portal and a client device to create a web communication feature for integration with secondary content, according to one example of principles described herein.

FIG. 5 is a diagram showing use of the web communication feature, according to one example of principles described herein.

FIG. 6 is a diagram showing an illustrative webpage that includes the web communication feature within secondary content, according to one example of principles described herein.

FIG. 7 is a flowchart showing an illustrative method for creating the web communication feature, according to one example of principles described herein.

FIG. 8 is a diagram showing an illustrative computing system that may perform functions related to the web communication feature, according to one example of principles described herein.

FIG. 9 is a diagram showing additional information provided to an agent of the second entity, according to one example of principles described herein.

### SUMMARY

According to one example, a method includes, with a service portal of a web communication service, receiving a first dataset from a computing device of a second entity, the first dataset including information to enable communication between a user device accessing a website of a first entity and an agent device of the second entity. The method further includes, with the service portal, creating a piece of code for insertion into content from the second entity that is configured for insertion into the website of the first entity, the piece of code to establish a communication session through the web communication service between the user device and the agent device. The method further includes transmitting the piece of code to the computing device of the second entity.

According to one example, a system includes a processor and a memory comprising machine readable instructions that when executed by the processor, cause the system to receive a first dataset from a computing device of a second entity, the first dataset including information to enable communication between a user device and an agent device of the second entity. The system is further to create a piece of code for insertion into content from the second entity that is configured for insertion into a website of a first entity, the piece of code to establish a communication session through a web communication service between the user device and the agent device, transmit the piece of code to the computing device of the second entity, receive an indication that a user of the user device has activated a link within the content for establishing the communication session, and in response to the indication, establish the communication session between the user device and the agent device.

According to one example, a method includes receiving a first dataset from a computing device of a second entity, the first dataset including information to enable communication between a user device and an agent device of the second entity. The method further includes creating a piece of code for insertion into content from the second entity that is configured for insertion into a website of a first entity, the piece of code to establish a communication session through a web communication service between the user device and the agent device. The method further includes receiving an indication that a user of the user device has activated a link within the content for establishing the communication session, the content having the piece of code integrated therein. The method further includes, in response to the indication, establishing the communication session between the user device and the agent device.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In some examples, a web site managed by one entity may include content from other entities. Specifically, the primary content of the website may be provided from a server associated with one entity while secondary content may be retrieved from a server associated with a different entity. For example, a search website may have the primary content related to an internet search. Additionally, secondary content from other entities may be presented. Such secondary content may be for the purposes of directing the user of the search website to the websites of the other entities in order to encourage the user to use those websites or purchase products or services from the other entities. In a further example, a social networking website may include primary content related to social networking activities. Secondary content from other entities may also be presented on the social networking website in an attempt to get the user of the social networking website to visit the websites of the other entities.

According to principles described herein, methods and systems allow for central management of embedding web communication services such as WebRTC services within secondary content of a website, particularly, where the secondary content is associated with a different entity than the entity associated with the primary content of the website. In one example, a web communication service offers a service portal through which entities may request a customized web communication feature. The customized web communication feature can be inserted into secondary content that is designed to be presented on various other websites. In one example, a second entity provides the web communication service with various parameters for the web communication feature. Such parameters may include the communication destinations (e.g., phone numbers) for a user initiated web communication session. The parameters may also include criteria for which of the communication destinations should be used based on information known about a particular user (e.g., location of the user).

Using the information received from the second entity, the web communication service may create a piece of code for integration with the second entity's secondary content. This piece of code may then be provided to the second entity. With the piece of code integrated into the second entity's secondary content, the secondary content may be made available on websites of various other entities. For example, the secondary content may be presented along with primary content of a website associated with a first entity. When a user is viewing the first entity's website, he or she may see the secondary content and wish to engage with the second entity. The user may then activate a link within the secondary content to establish a communication session between the user and the second entity. In response to receiving an indication that the user has activated such a link, the web communication service will establish the communication session in a manner consistent with the parameters that were defined by the second entity.

For purposes of discussion, a first entity, refers to the entity associated with primary content. A second entity refers to a provider of secondary content to be presented on a variety of different websites, such as those hosted by the first entity. Thus, the first entity allows secondary content from other entities (e.g., the second entity) to be presented along with their primary content. A user refers to a visitor of the first entity's website, who may also wish to engage with the second entity.

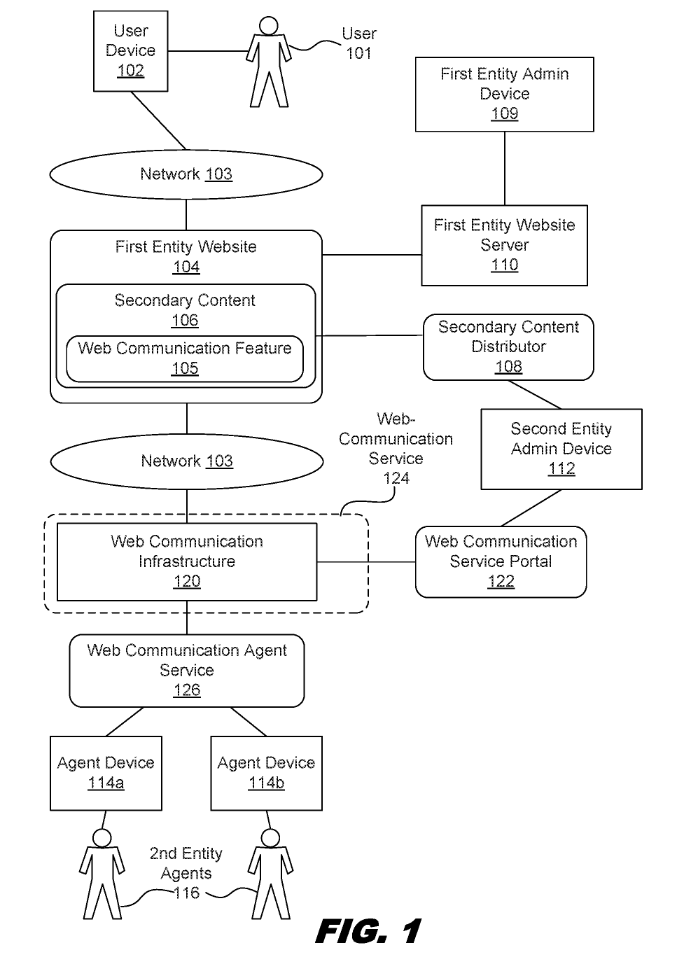

FIG. 1 illustrates an example of the environment 100 in which a user may contact a second entity through secondary content on a first entity's website. According to the present example, the environment 100 includes devices associated with a user 101, devices associated with a first entity, devices associated with a web communication service 124, and devices associated with a second entity. The devices from the different entities, web communication service 124, and user 101 interact with a website 104.

The first entity may be an organization such as a business or government agency. The first entity is associated with a first entity website server 110. That is, the first entity may own, operate, manage, or lease the first entity website server 110. The first entity website server 110 may be one or more physical computing systems that are able to host a website 104 for presentation to users such as user 101. For example, the website 104 may be a search site or social networking site. Other types of sites are contemplated. The website 104 provides primary content to the user. In addition, the first entity may allow secondary content 106 from other entities to be presented on the website 104.

The second entity may also be an organization such as a business or government agency. In addition, the second entity may wish to get the attention of users visiting other websites. For example, the second entity may wish to sell its products or services to visitors of other websites (e.g., website 104).

The second entity is associated with a second entity administrator device 112. The second entity administrator device 112 may be, for example, a computing device of a person tasked with providing secondary content to other websites. The second entity admin device 112 may provide secondary content 106 to a secondary content distributor 108. The secondary content distributor may own, operate, manage, or lease various servers that host secondary content for presentation on other websites, such as website 104. The secondary content 106 includes a web communication feature 105 that when activated by a user, connects the user to an agent 116 of the second entity.

The agents 116 of the second entity may be associated with agent devices 114a, 114b. The agent devices may be operated by second entity agents 116. In one example, the second entity agents 116 are associated with call centers and are set up to communicate with and provide service to users who wish to interact with the second entity. The agent devices 114a, 114b may be physical computing systems or other types of communication equipment that are capable of using the web communication service 124 to communicate with users, such as user 101.

The web communication service 124 includes a web communication infrastructure 120. The web communication infrastructure 120 includes all the hardware, software, and other types of equipment needed to provide a web communication service. In one example, the web communication service 124 is a webRTC service.

The web communication infrastructure 120 is associated with a web communication service portal 122. The web communication service portal 122 is the means through which a customer, such as the second entity 118, interacts with the web communication service 124 to create the web communication feature 105. For example, the web communication service portal 122 may allow a representative from the second entity to provide the web communication services with various parameters for the web communication feature, such as which of the agents 116 and under what conditions calls should be directed to such agents 116 when a user interacts with the web communication feature 105. The web communication service may then provide the second entity with a piece of code designed for integration with the second entity content 106. Thus, the second entity does not have to create the code but instead relies on the web communication service 124. In this way, the web communication feature is centrally managed.

With such an environment 100, a user 101 may use his or her device 102 (e.g., a laptop computer, desktop computer, mobile phone, etc.) to access the first entity's website 104. While using the first entity's website, the user may notice the second entity's content 106 and wish to interact with the second entity. The user may then activate the web communication feature. Upon activation, the web communication service 124 sets up a communication session between the user's device 102 and one of the agent devices 114a, 114b of the second entity.

The user device 102 may be, for example, a laptop computer, a desktop computer, or a mobile phone. The user device 102 may be connected to a network such as the Internet in order to access the website 104. The website 104 includes primary content associated with the first entity and secondary content 106 associated with the second entity. In general, the primary content may be stored on the first entity website server 110. The primary content may be placed on the first entity website server from a first entity administrator device 109. The first entity may own, operate, manage, or lease the server 110. In some examples, server 110 represents a plurality of servers working together to provide the primary content. The primary content may be stored on the server 110 and provided to the user device 102 upon request to view the website 104. An application, such as a browser, the user device 102 then renders the primary content for display to the user.

As described above, the website 104 also provides secondary content 106. In some examples, the secondary content is stored on a server associated with a secondary content distributor 108. However, in some examples, the secondary content 106 may be stored on a server associated with the second entity. While viewing the website 104 the secondary content 106 stored on a different server than the first entity website server 110 will also be provided to the user device 102. The application (e.g., browser) will display the secondary content 106 to the user as well as the primary content. In one example, the website 104 may be a news site. Thus, the primary content may be the news provided by the news site and the secondary content may be designed to get the attention of the user in order to draw the user to the second entity. As described above, the secondary content 106 includes a web communication feature 105. When activated by the user, the web communication feature 105 may call on the web communication service 124 to establish a communication session between the user device 102 and an agent device 114a, 114b associated with the second entity. The communication session may be one of voice, video, or text. In some examples, the user may designate through the web communication feature which communication mode he or she wishes to use. In some examples, the communication mode (i.e., voice, video, picture, desktop sharing, application sharing, file transfer, and text) may be limited by the capabilities of the user device. For example, if the user device does not have a camera, the user will not be able to engage in video communication.

The web communication service 124 may use web-based communication services as well as traditional telephony services. For example, establishing the communication session may involve dialing a phone number provided by the user for the user device 102. In some examples, establishing the communication session may involve dialing a phone number of the agent device 114a, 114b. If both the agent device and the user device 102 are capable of communicating through IP-based communication technologies, then IP-based communication session (e.g., Voice over IP (VoIP)) may be established. In some examples, both the user device 102 and one of the agent devices 114a, 114b may be capable of using webRTC technology. In such a case, the communication session may be a webRTC communication session.

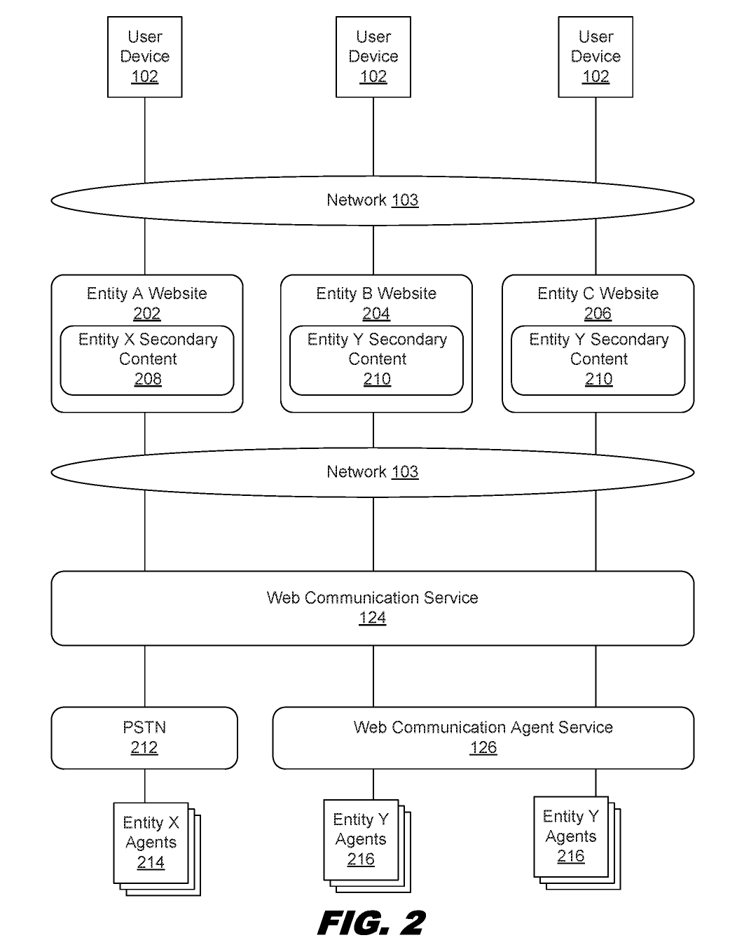

FIG. 2 is a diagram showing various pieces of secondary content 208, 210 presented on various websites 202, 204, 206. In the present example, users may use user devices 102 to access the websites 202, 204, 206 over a network 203 such as the Internet. Entity A, Entity B, and Entity C may be similar to the first entity described above. Additionally, Entity X and Entity Y may be similar to the second entity described above. In the present example, Entity A's website 202 includes Entity X's secondary content 208. Both Entity B's website 204 and Entity C's website 206 include Entity Y's secondary content. The secondary content 208, 210 may be handled by a distributor such as the secondary content distributor 108 described above.

Each of the pieces of secondary content 208, 210 may have a web communication feature that facilitates connecting users with agents of the appropriate entity. Each of the web communication features within the pieces of secondary content may be managed by the web communication service 124. Specifically, the web communication service 124 may provide the code for such web communication features and may host at least part of the functionality of such web communication features.

In some examples, the web communication service 124 may connect users to certain agents using a traditional phone service such as a Public Switched Telephone Service (PSTN). In the present example, secondary content 208 for Entity X directs users to Entity X agents 214 using a PSTN. The web communication service may also use a web communication agent service 126 to connect with agents. For example, the agents of Entity Y may have computing devices that are enabled for the web communication service, such as WebRTC. The web communication agent service 126 works with the web communication service 124 to provide communication services directly to the agents 216. In the present example, Entity Y's secondary content is presented on at least two different entity's websites 204, 206. Thus, a user visiting either website 204, 206 can contact an Entity Y agent using the web communication feature embedded within the secondary content 210.

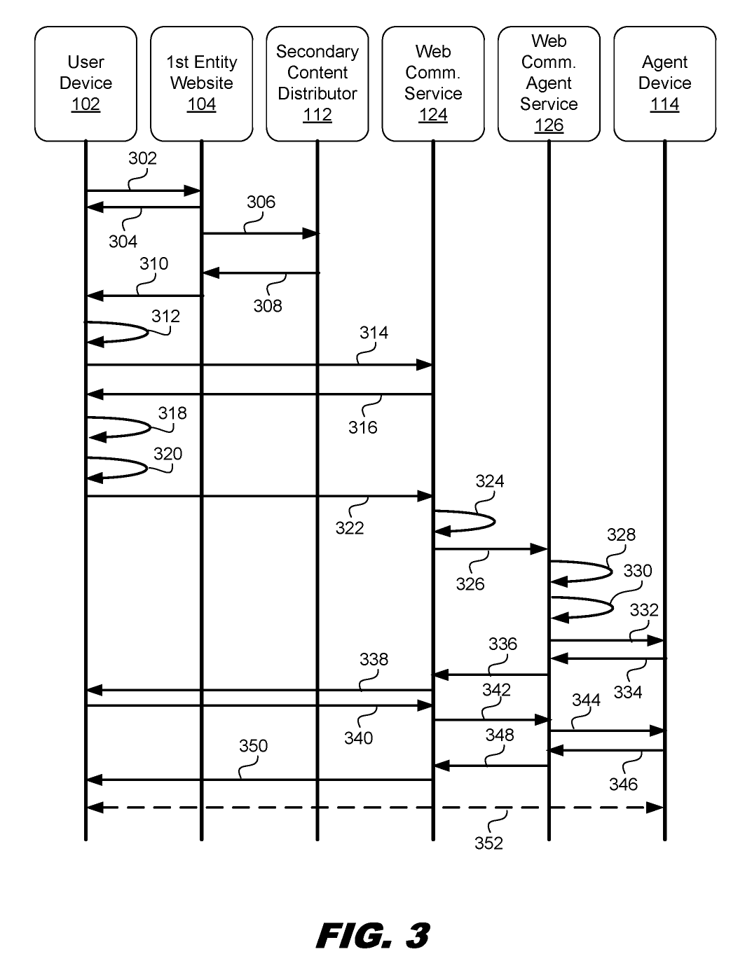

FIG. 3 is a flow diagram showing a user's interaction with a web communication feature embedded within secondary content of a website. According to the present example, at step 302, a user accesses the first entity's website 104 using his or her user device 102. For example, the user may enter a Uniform Resource Locator (URL) into his or her browser to access the first entity website 104. At step 304, the first entity website 104 responds by sending website content back to the user device 102. This content may be formatted, for example, in hypertext markup language (HTML). The content may also include JavaScript and other the web content formats.

Additionally, at step 306, the first entity website 104 requests secondary content from the secondary content distributor 112. At step 308, the secondary content distributor 112 selects one of a variety of pieces of secondary content to provide to the first entity website 104. The selection is based on a variety of factors including the nature of the first entity website 104, or any other information obtained from the user. The secondary content provided to the first entity website 104 also includes code for the web communication feature described above. At step 310, the first entity website 104 provides the secondary content to the user device 102, along with the code to create the web communication feature for the user.

At step 312, the user interacts with the secondary content. In response to the user interacting with the secondary content, the user device 102 uses the code provided with the secondary content to request a user interface associated with the second entity at step 314. In other words, the user device is requesting a user interface designed by the second entity for use by the user. In response, at step 316, the web communication service provides the user device 102 with code to present the user interface.

Step 318, the user device 102 presents the user interface for the web communication feature to the user. Specifically, the user device 102 uses the code for the interface retrieved in steps 314 and 316. At step 320 the user pushes a button indicating that the user wishes to contact the second entity. For example, the user may type a message within a text entry field, the message indicating that the user wishes to speak with a representative of the second entity.

At step 322, the user device 102 sends a message to the web communication service 124. In the present example, the message may be a text formatted message that says “I need help.” In response to the user sending the message, the web communication feature 124 determines a destination address for the second entity. In some examples, the destination address may be a terminating address for the second entity. The terminating address may be a single address behind which multiple addresses associated with various agents exist. For example, the terminating address may be to the web communication agent service 126. In such example, the process continues at step 326, in which the web communication service 124 forwards the message from the user device 102 to the web communication agent service 126.

At step 328, the web communication agent service 126 puts the message in a queue until an agent is available. At step 330, it is determined that an agent becomes available. At step 332, the message is forwarded to the available agent's agent device 114. At step 334, the agent responds to the message. For example, the agent may respond with a message that states: “how can I help?” At step 336, the web communication agent service 126 forwards the response to the web communication service 124. At step 338, the web communication service 124 forwards the response back to the user device 102.

At step 340, the user requests to engage the agent in a voice call. For example, the user may push a button within the user interface of the web communication feature to call the agent. Thus, the user device 102 sends a request to start the voice call to the web communication service 124. In response, the web communication service forwards the request to start the voice communication to the web communication agent service 126 at step 342. The web communication agent service 126 then forwards the request for a voice communication to the agent device 114 at step 344. At step 346, the agent responds with an answer message to the web communication agent service 126. The web communication agent service 126 then forwards the answer to the web communication service 124 at step 348. At step 350 the web communication service 124 forwards the answer back to the user device 102. At step 352, a voice communication is established between the user device 102 and the agent device 114.

In some examples, the user may first communicate with a bot agent. For example, an artificial intelligence programmed to respond to user questions may interact with the user. At some point during the conversation with the bot, the user may be redirected from the bot to a live agent.

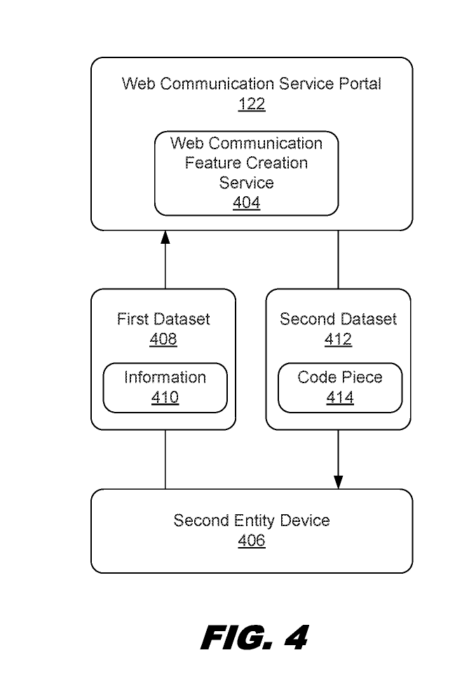

FIG. 4 is a diagram showing communication between a communication service portal and a second entity device to create a web communication feature for integration with secondary content. FIG. 4 illustrates data passed between the web communication service portal 122 and a second entity device 406. The second entity device 406 may be a computing system operated by a representative of the second entity.

In one example, a user may access a web communication feature creation service 404 through the web communication service portal 122. The web communication feature creation service 404 may include the hardware, software, or combination of both to provide customers with the ability to create a web communication feature. The web communication feature creation service 404 may provide a user interface to customers through, for example, a website. The user interface may provide the customer with the tools to create a customized web communication feature that connects users with the desired persons associated with the second entity.

According to the present example, a first dataset 408 is sent from the second entity device 406 and received by the web communication service portal 122. The first dataset 408 includes any data that is sent together or separately to the web communication service portal 122 for use by the web communication feature creation service 404. The first dataset 408 includes information 410 that is used to customize the web communication feature.

Such information 410 may include a set of destination addresses for the agents of the second entity to which a user should be connected, or a terminating destination address for the second entity. The destination addresses may be, for example, a phone number for such agents. In examples that involve communication to Internet Protocol (IP) destinations, the destination addresses may be IP addresses. The information 410 may also specify criteria as to which subsets of the set of destination addresses should be used under certain circumstances. Such circumstances may include information obtained from the user or the first entity website on which the second entity content is being displayed. One such circumstance may be the language in which the website of the first entity is rendered. For example, if the website is being rendered in French, then the user should be routed to a destination address of an agent that speaks French. Additionally, based on the location of the user, a certain subset of destination addresses may be used.

In some examples, the user may provide additional information through the web communication feature that may help identify a subset of the destination addresses to which the user should be connected. Thus, the information 410 may specify what is to be requested from the user and which destination addresses should be used based on responses from the user. Other types of information 410 that may be helpful for connecting the user to the desired agent of the second entity may be included as well.

With the information 410 received in the first data set 408, the web communication feature creation service 404 may create a piece of code 414, alternatively referred to as a code piece 414. The code piece 414 may then be sent in a second dataset 412 from the web communication service portal 122 to the second entity device 406. The second entity may then use that code piece 414 for integration with secondary content.

The code piece 414 may include machine readable instructions that when executed, cause the system executing the code to establish communication between a user and a communication destination specified in the code. In some examples, the code may include a Universal Resource Locator (URL) to resources associated with the web communication service (e.g., 124, FIG. 1). In some examples, the code piece 414 may include proprietary data from the web communication service 124. The code piece 414 may include the logic to present the web communication feature to the user and to establish communication sessions to various communication destinations based on user input. The code piece 414 may also be configured for a particular software platform as defined by the second entity.

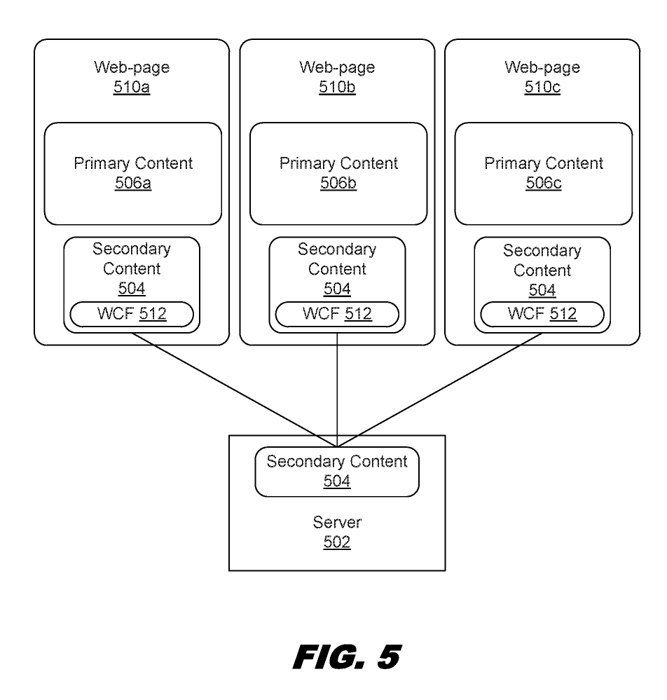

FIG. 5 is a diagram showing multiple illustrative websites 510a, 510b, 510c that include the web communication feature 512 within the secondary content 504. Each of the different websites 510a, 510b, 510c may be associated with different entities. For example, website 510a may be a food-related website in which the primary content 506a is food-related. Website 510b may be a social networking site in which the primary content 506b is social networking content. Website 510c may be a search site in which the primary content 506c is search content. Each website 510a, 510b, 510c may include the same secondary content 504 from the second entity. Each instance of that secondary content 504 may also include the web communication feature 512.

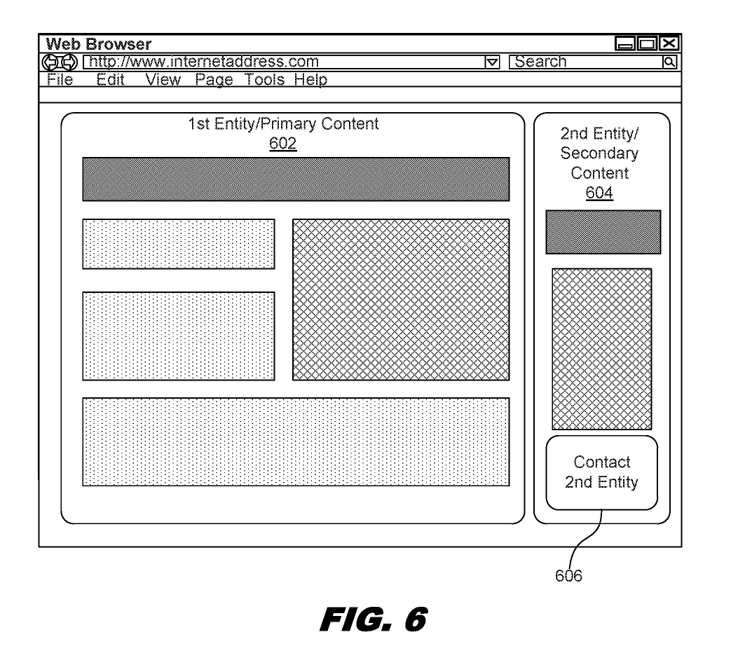

FIG. 6 is a diagram showing an illustrative webpage of a website, the webpage including the web communication feature within secondary content. According to the present example, a website is rendered for display to a user on a user device. The website displays primary content 602 from the first entity within a majority of the screen space. The secondary content 604 from the second entity is displayed in a smaller portion of the screen space. The secondary content 604 includes the web communication feature 406 that allows the user to contact the second entity. As described above, when the user clicks the web communication feature, he or she is connected to an agent of the second entity through the web communication service. The webpage may be rendered using a variety of technologies including, but not limited to, Hypertext Markup Language (HTML), eXtensible Markup Language (XML), and Javascript.

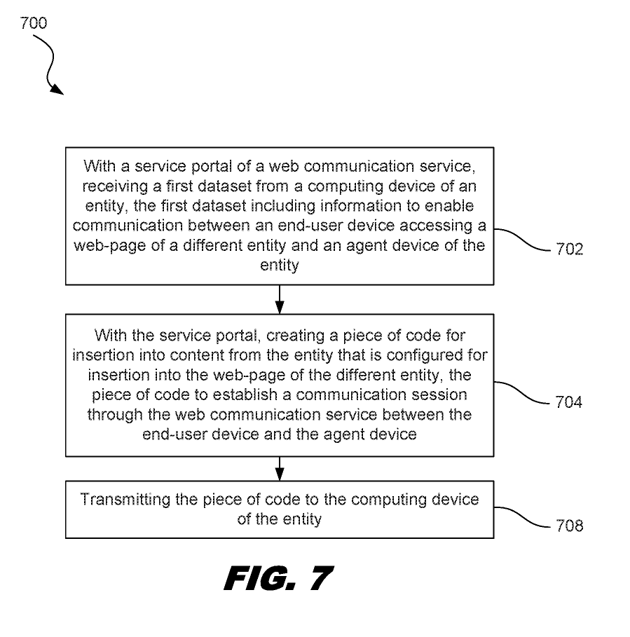

FIG. 7 is a flowchart showing an illustrative method 700 for creating the web communication feature. According to the present example, the method 700 includes a process 702 for, with a service portal of a web communication service, receiving a first dataset from a computing device of a second entity. The first dataset includes information to enable communication between a user device accessing a website of a first entity and an agent device of the first-entity. As described above, the second entity may be an organization such as a business. That business may wish to present content on the websites of other entities, e.g., the first entity. The first entity may also be an organization such as a business that may agree to include content from other entities on its website.

The method 700 further includes a process 704 for, with the service portal, creating a piece of code for insertion into content from the second entity that is configured for insertion into the website of the first entity. The piece of code is configured to establish a communication session through the web communication service between a user device and the agent device.

The method 700 further includes a process 706 for transmitting the piece of code to the computing device of the second entity. With the piece of code, the second entity can integrate a web communication feature into its secondary content that is made available on the websites of other entities. This web communication feature provides a user with easy access to the appropriate agents of the second entity. The piece of code may be integrated into the secondary content in a variety of manners. For example, the piece of code may be formatted as HTML code and may be inserted into the HTML code for the secondary content. In some examples, the piece of code may be formatted as a Java applet. A link to the Java applet may then be inserted into the code for the secondary content. Thus, when the user clicks the link, the Java applet can be downloaded to the user's computer and executed in the context of the user's browser. Other methods of integration may be used based on the preferences specified by the second entity.

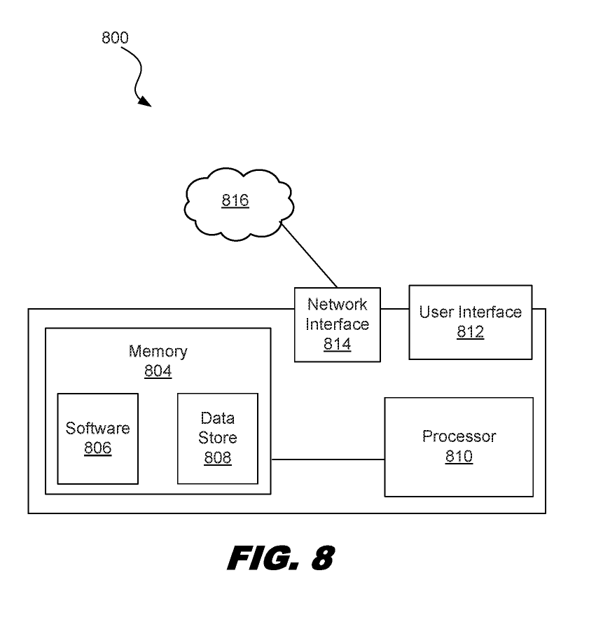

FIG. 8 is a diagram showing an illustrative computing system that may perform functions related to the web communication feature, such as the functions described above in the text accompanying FIG. 7. The computing system 800 may also be one of: a user device, a second entity device, a second entity server, a first entity server, or a second entity agent device. According to certain illustrative examples, the computing system 800 includes a memory 804 which may include software 806 and a data store 808. The processing system 800 also includes a processor 810, a network interface 814, and a user interface 812.

The memory 804 may be one of several different types of memory. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various types of memory may store information in the form of software 806 and data in the data store 808.

The computing system 800 also includes a processor 810 for executing the software 806 and using or updating the data 808 stored in memory 804. The software 806 may include an operating system and any other software applications a user may wish to install. The software 806 may be, for example, software designed to provide a web communication feature creation service. In such case, the computing system 800 may be associated with the web communication service. In some examples, the computing system 800 may be associated with a user. In such case, the software 806 may be an application to render web content, such as a browser. The software 806 may include machine readable instructions of a computer program product that when executed, perform the functions described above in accordance with the text accompanying FIG. 5.

The user interface 812 may include a number of input devices such as a mouse, touchpad, or touchscreen that allow the user 802 to interact with the computing system 800. The user interface 812 may also include a number of different types of output devices such as a monitor or a touchscreen. The user interface allows the user 802 to interact with the processing system 500 in a manner as described above.

The network interface 814 may include hardware and software that allows the processing system 800 to communicate with other processing systems over a network 816. The network interface 814 may be designed to communicate with the network 816 through hardwire media such as Ethernet, coaxial, fiber-optic, etc. The network interface 814 may also be designed to communicate with the network 816 using wireless technologies.

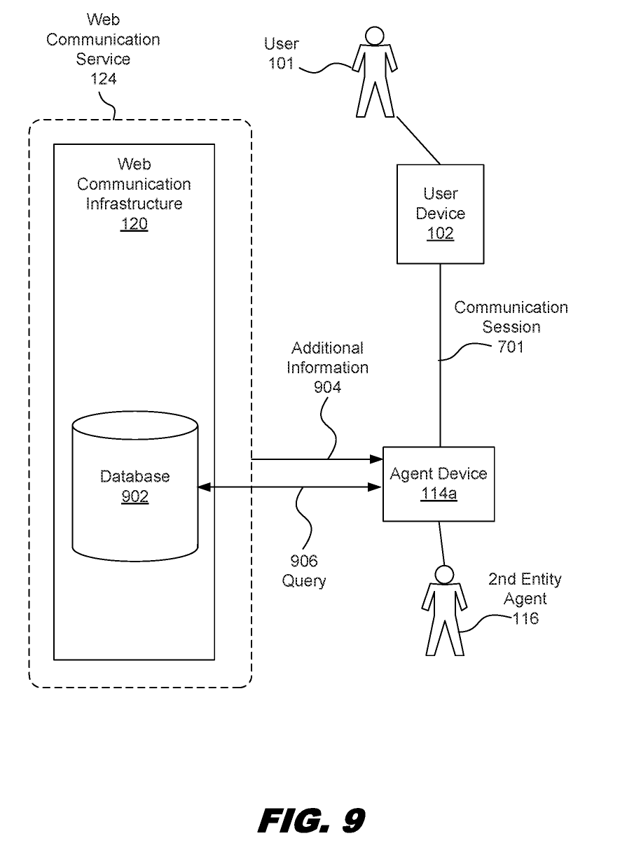

FIG. 9 is a diagram showing additional information provided to an agent of the second entity. In some examples, when a user 101 is connected to an agent 116 through the web communication session, the agent 116 may be provided with additional information associated with the communication session. For example, the agent device 114 may be provided with a unique identifier that uniquely identifies the content in which the web communication feature used to indicate the communication session 901 was used. Thus, the agent 116 is made aware of the piece of secondary content the user 101 was looking at when he or she initiated the communication session 901. This may be particularly useful to the agent if the second entity has several different types of content (e.g., for different products or services) for display on various websites.

In some examples, the additional information 904 may include other information that may be helpful for the agent. For example, if the piece of secondary content into which the web communication feature is inserted is set up to allow user input, then any such input may be provided to the agent. The additional information 904 may indicate the website of first entity in which the secondary content through which the user contacted the second entity was placed. The additional information may include the language in which that website is rendered. The additional information may be location information associated with the user.

In some examples, the agent 116 may be provided with the ability to query 906 a database 902 of the web communication infrastructure 120 for records associated with the particular piece of secondary content through which the user 101 contacted the second entity. This may allow the agent to obtain data associated with the secondary content, such as how often it is presented to users, how often users choose to contact the second entity, etc. The database 902 may include other records that may be of interest to the agent.

In some examples, the additional information 904 that is sent to the agent is specified in the first dataset (e.g., 408, FIG. 4) that is sent to the web communication service portal 122 when the second entity is having the web communication feature created. For example, the second entity may provide the web communication service with a unique identifier for the secondary content into which the web communication feature will be inserted. The second entity may also specify what other types of information should be obtained and provided to the agent 116 when a user 101 chooses to contact the second entity.

Some examples of processing systems described herein may include non-transitory, tangible, machine readable media that include executable code that when run by one or more processors may cause the one or more processors to perform the processes of methods as described above. Some common forms of machine readable media that may include the processes of methods are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
with a service portal of a web communication service, receiving a first dataset from a computing device of a second entity, the first dataset including information to enable communication between a user device accessing a website of a first entity and an agent device of the second entity;
with the service portal, creating a piece of code for insertion into content from the second entity that is configured for insertion into the website of the first entity, the piece of code to establish a communication session through the web communication service between the user device and the agent device; and
transmitting the piece of code to the computing device of the second entity.

2. The method of claim 1, wherein the web communication session is a Web Real Time Communication (WebRTC) session.

3. The method of claim 1, further comprising, with a communication infrastructure of the web communication service, receiving an indication that the piece of code has been activated by a user of the user device.

4. The method of claim 3, further comprising, with the communication infrastructure, establishing the communication session between the user device and the agent device.

5. The method of claim 1, wherein the communication session includes at least one of the following media: voice, video, picture, desktop sharing, application sharing, file transfer, text.

6. The method of claim 1, wherein a modality of the communication session is based on capabilities of the user device.

7. The method of claim 1, wherein the information defines a set of agents to which the communication session may be established based on a set of conditions.

8. The method of claim 7, wherein the set of conditions includes the website of the first entity.

9. The method of claim 7, wherein the set of conditions includes at least one of: a location of a user of the user device and a language in which the website is rendered.

10. The method of claim 1, wherein the piece of code causes a unique identifier of the content to be sent to an agent to which the communication session is established.

11. The method of claim 10, further comprising, with the web communication service, providing a user interface to the agent to which the communication session is established, the user interface providing the agent with an ability to query records associated with the content.

12. The method of claim 10, further comprising, with the web communication service, providing the agent with a context in which the content was presented to the user in the website.

13. A system comprising:
a processor; and
a memory comprising machine readable instructions that when executed by the processor, cause the system to:
receive a first dataset from a computing device of a second entity, the first dataset including information to enable communication between a user device and an agent device of the second entity;
create a piece of code for insertion into content from the second entity that is configured for insertion into a website of a first entity, the piece of code to establish a communication session through a web communication service between the user device and the agent device;
transmit the piece of code to the computing device of the second entity;
receive an indication that a user of the user device has activated a link within the content for establishing the communication session; and
in response to the indication, establish the communication session between the user device and the agent device.

14. The system of claim 13, wherein the communication session includes one of the following media: voice, video, picture, desktop sharing, application sharing, file transfer, and text.

15. The system of claim 13, further comprising, with the web communication service, receiving multiple indications from multiple websites of multiple different entities, each of the websites including the content from the second entity.

16. The system of claim 13, wherein the web communication service selects one of a plurality of agent devices of the second entity with which to establish the communication session based on conditions defined in the information.

17. The system of claim 16, wherein the conditions include at least one of: a website through which the indication was received, a location of the user device, and a language in which the website through which the indication was received is rendered.

18. A method comprising:
receiving a first dataset from a computing device of a second entity, the first dataset including information to enable communication between a user device and an agent device of the second entity;
creating a piece of code for insertion into content from the second entity that is configured for insertion into a website of a first entity, the piece of code to establish a communication session through a web communication service between the user device and the agent device;
receiving an indication that a user of the user device has activated a link within the content for establishing the communication session, the content having the piece of code integrated therein; and
in response to the indication, establishing the communication session between the user device and the agent device.

19. The method of claim 18, wherein the web communication session is a Web Real Time Communication (WebRTC) communication session.

20. The method of claim 18, further comprising, providing the agent device with data associated with the user and the website that includes the content.
